(19) United States
(12) Patent Application Publication
(10) Pub. No.: US 2012/0240378 A1
(43) Pub. Date: Sep. 27, 2012

(54) LOADER FOR IMPLANT DELIVERY TOOLS AND METHODS OF USING THE SAME

(75) Inventors: Michael F. Weiser, Groton, MA (US); Jeffery Bean, Fitchburg, MA (US); Nareak Douk, Lowell, MA (US); John Sherry, Needham, MA (US)

(73) Assignee: BOSTON SCIENTIFIC SCIMED, INC., Maple Grove, MN (US)

(21) Appl. No.: 13/424,862

(22) Filed: Mar. 20, 2012

Related U.S. Application Data
(60) Provisional application No. 61/467,266, filed on Mar. 24, 2011.

(51) Int. Cl. B23P 11/00

(52) U.S. Cl. 29/428; 29/700

(57) ABSTRACT

An apparatus includes a base portion, a first side portion, and a second side portion. The base portion, the first side portion, and the second side portion collectively define a cavity. The cavity is configured to receive a filament. The cavity is also configured to receive at least a portion of a delivery tool such that a coupling portion of the delivery tool is aligned with the filament. In some embodiments, the cavity includes a first end portion and a second end portion. The cavity is configured to receive the filament such that it extends from the first end portion of the cavity to the second end portion of the cavity. The cavity is configured to receive the at least a portion of a delivery tool such that the coupling portion of the delivery tool is disposed between the first end portion of the cavity and the second end portion of the cavity.

### CROSS REFERENCE TO RELATED APPLICATION

This application is a nonprovisional of, and claims priority to, U.S. Patent Application No. 61/467,266, filed on Mar. 24, 2011, entitled “LOADER FOR IMPLANT DELIVERY TOOLS AND METHODS OF USING THE SAME”, the disclosure of which is incorporated by reference herein in its entirety.

### TECHNICAL FIELD

This disclosure relates generally to a loader for implant delivery tools and methods of using such loaders.

### BACKGROUND

A variety of medical procedures are performed to provide support to portions of a body of a patient. For example, some medical procedures are performed to treat various female pelvic dysfunctions, including procedures to treat urinary incontinence, and correcting various prolapse conditions such as uterine prolapse, cystoceles, rectoceles, and vaginal vault prolapse.

Some such medical procedures have included placing implants within the pelvic region of the patient. Some of the implants are delivered to the pelvic region of the patient through one or more vaginal incisions, and/or through exterior incisions in the patient.

Often such implants are delivered or placed within the body of the patient using an insertion or delivery tool. The insertion tools used to deliver the implants within a body of a patient typically include a curved portion and a sharp needle or point at one end. In some of the insertion tools the sharp needles or points are removably coupled to the insertion tools. In such embodiments, the sharp needles or points are loaded or coupled to the insertion tool by the physician prior to using the insertion tool to insert the implant into the body of the patient and are typically removed from the insertion tool after the insertion of the relevant portion of the implant.

The size of the sharp needles or point and/or the shape of some delivery tools can cause the loading or coupling of the sharp needles or point to the delivery tools difficult and/or time consuming to achieve. For example, small needles or points might be difficult to handle particularly in a surgical setting. Additionally, the coupling portion of the delivery tools may require that that needles or points be place at a particular location or in a particular orientation. Furthermore, the additional handling of sharp needles or points can be unsafe and can lead to unintentional cuts or punctures.

Thus, it is desirable to provide a loading device that allows or facilitates the loading or coupling of a filament or needle to a delivery tool.

### SUMMARY

An apparatus includes a base portion, a first side portion, and a second side portion. The base portion, the first side portion, and the second side portion collectively define a cavity. The cavity is configured to receive a filament. The cavity is also configured to receive at least a portion of a delivery tool such that a coupling portion of the delivery tool is aligned with the filament. In some embodiments, the cavity includes a first end portion and a second end portion. The cavity is configured to receive the filament such that it extends from the first end portion of the cavity to the second end portion of the cavity. The cavity is configured to receive the at least a portion of a delivery tool such that the coupling portion of the delivery tool is disposed between the first end portion of the cavity and the second end portion of the cavity.

### BRIEF DESCRIPTION OF THE DRAWINGS

FIG. 1 is a schematic illustration of a loader according to an embodiment.

FIG. 2 is a perspective view of a loader according to an embodiment.

FIG. 3 is a perspective view of a delivery tool.

FIG. 4 is a schematic illustration of an implant coupled to a delivery aid.

FIGS. 5-10 illustrate a use of the loader of FIG. 2.

FIGS. 11-13 are perspective views of loader according to embodiments.

FIG. 14 is a side view of the loader of FIG. 13.

FIG. 15 is a perspective view of the loader of FIG. 13 engaged with a delivery tool.

FIG. 16 is a perspective view of a loader according to an embodiment.

FIG. 17 is a side view of the loader of FIG. 16.

FIG. 18 is a perspective view of a loader engaged with a delivery tool according to an embodiment.

FIG. 19 is a perspective view of a loader engaged with a delivery tool according to an embodiment.

FIG. 20 is a flow chart of a method of loading a delivery tool using a loader.

### DETAILED DESCRIPTION

The devices and methods described herein are generally directed to loading devices that can be used to load or couple implants to insertion or delivery tools. The insertion or delivery tools may be used for placing the implants within a body of a patient. The implants delivered with the insertion or delivery tools include, but are not limited to, implants that are placed within a pelvic region of a patient. For example, the implants that may be placed with the disclosed insertion or delivery tools include posterior support implants, anterior support implants, and total pelvic floor repair implants. Such implants can be placed into the pelvic space of a patient and secured at any of several locations within the pelvic space to treat many different pelvic floor dysfunctions. For example, an implant can be secured to a sacrospinous ligament or a ureterosacral ligament for uterine preservation (e.g., if a prolapsed uterus is otherwise healthy, a hysterectomy is not preformed and the uterus is re-suspended with an implant), or for posterior support. In another embodiment, an implant can be secured to pubo-urethral tissue or an obturator muscle (e.g., internus or externus) or membrane (each also referred to herein as “obturator”) to treat, for example, incontinence. In yet another embodiment, an implant can be secured to a sacrospinous ligament or an arcus tendineus fascia pelvis (i.e., white line) (also referred to herein as “arcus tendineus”) for paravaginal repairs including, for example, cystoceles, rectoceles and enteroceles. An implant can also be secured to various combinations of such locations. The insertion tools, implants, and procedures described herein may be used in a female patient or a male patient.

In some embodiments, the insertion or delivery tool may be used to place an implant, for example, through a vaginal incision, in a retro-pubic direction (behind the pubic bone), or in a pre-pubic direction (in front of the pubic bone). In other embodiments, an implant can be placed in the direction of other anatomical structures or tissues as desired. A procedure to deploy a pelvic implant can include vaginal incisions, such as an anterior vaginal incision and/or an anterior vaginal incision. In some embodiments, a procedure may include an exterior incision.

As used herein, the terms proximal portion or proximal end refer to the portion or end, respectively, of a device that is closest to a physician when performing a medical procedure, and the terms distal portion or distal end refer to the portion or end, respectively, of the device that is furthest from the physician during a medical procedure. For example, a distal end or portion of an insertion tool or device as described herein refers to the end or portion of the device that is first inserted into a body of a patient during a medical procedure. The proximal end or portion is the end or portion of the device that is remains outside of the body of the patient during the insertion procedure (or if the entire device is inserted into the body of the patient during the delivery procedure, the proximal end portion is inserted into a body of the patient after the distal end or distal portion is inserted). The terms “trailing end” and “leading end” are also referred to herein and have similar meanings as proximal and distal, respectively. As used herein, the term “leading end” refers to the end of a device or apparatus that is inserted into a body first. The term “trailing end” refers to the end of the device or apparatus that remains outside of the body of the patient or is inserted into the body after the leading end.

Various embodiments of loaders or loading mechanism are disclosed herein. The loaders or loading mechanisms may be used to load or associate a needle or filament member of a variety of different implants with a variety of different delivery tools and only some examples of such implants and delivery tools are described herein.

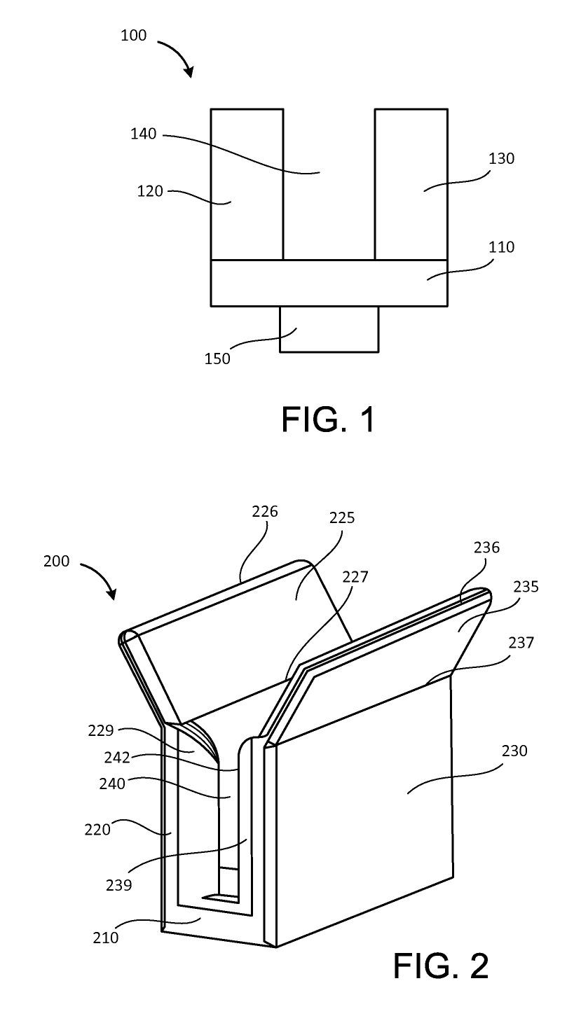

FIG. 1 is a schematic illustration of a medical device or loader 100 according to an embodiment of the invention. The loader 100 includes a base portion or member 110, a first side portion or member 120, and a second side portion or member 130. The base member 110, the first side member 120, and the second side member 130 collectively define a cavity 140.

In some embodiments, the base member 110, the first side member 120 and the second side member 130 are unitary or are unitarily or monolithically formed. In other words, the base member 110, the first side member 120, and the second side member 130 are formed of a single piece of material. In other embodiments, the base member 110, the first side member 120, and the second side member 130 are separate pieces of material and are coupled together. For example, in some embodiments, the base member 110 is coupled to the first side member 120 and the second side member 130. Specifically, in some embodiments, an adhesive, heat bonding or other mechanism may be used to couple the base member 110 to the first side member 120 and to the second side member 130.

The cavity 140 is configured to receive at least a portion of a filament. In some embodiments, the cavity 140 includes a first end portion and a second end portion and the cavity is configured to receive the filament such that the filament extends from the first end portion of the cavity to the second end portion of the cavity.

In some embodiments, as will be discussed in detail below, the filament is a portion of a bodily implant or is otherwise coupled to a portion of a bodily implant. For example in some embodiments, the filament includes a first end portion coupled to a bodily implant. In some embodiments, the filament includes a second end portion that has or is coupled to a sharp point such as a needle. The sharp point may be used to penetrate bodily tissue during the delivery of the implant into the body of a patient.

The cavity 140 is also configured to receive a portion of a delivery tool. The delivery tool may be used to insert an implant into the body of the patient. In some embodiments, cavity 140 is configured to receive at least a portion of the delivery tool such that the delivery tool is aligned with the filament which is disposed within the cavity 140 of the loader 100.

As will be described in more detail below, in some embodiments, the delivery tool includes a coupling portion. The coupling portion is configured to removably couple the filament (and thus, the implant) to the delivery tool. In some embodiments, the cavity 140 is configured to receive the coupling portion of the delivery tool. For example, in some embodiments, the cavity 140 is configured to receive the coupling portion of the delivery tool such that the coupling portion is aligned with the filament.

In some embodiments, the loader 100 includes a coupling member 150. The coupling member 150 is configured to couple the loader 100 to a larger object. For example, in some embodiments, the coupling member 150 is configured to couple the loader 100 is a surface of a table. For example, in some embodiments, the coupling member 150 is a magnet or includes an adhesive, or other type of material (such as hook-and-loop material) that allows the loader 100 to be coupled to a surface of a larger object, such as a table. In other embodiments, the coupling member 150 is configured to couple the loader 100 to the body of the physician, such as a finger of the physician. In yet further embodiments, the coupling portion 150 is configured to couple the loader 100 to the packaging of the implant.

Although the coupling portion 150 is illustrated as being coupled to the base member 110 of the loader 100, the coupling portion 150 may be disposed on or coupled to any portion of the loader 100. For example, the coupling portion 150 may be disposed on the first side portion 120 or the second side portion 130 of the loader 100. Additionally, in some embodiments, the coupling portion 150 is integrally or monolithically formed with a portion of the loader 100.

As will be described in more detail below, once the filament and a portion of the delivery tool are disposed in the cavity 140, the filament may be moved with respect to the loader 100 and the delivery tool. For example, the filament may be slid or moved within the cavity 140. As discussed above, the delivery tool, including the coupling portion of the delivery tool, are aligned with the filament. Accordingly, as the filament moves with respect to the delivery tool, the filament will become associated with the delivery tool. In some embodiments, the filament will be coupled to the delivery tool. In some embodiments, a needle coupled to an end portion of the filament will be coupled to the delivery tool as the filament is moved with respect to the loader 100 and the delivery tool.

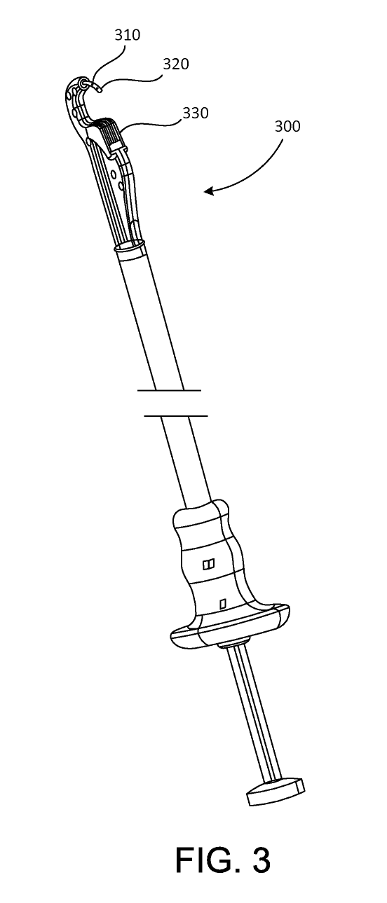

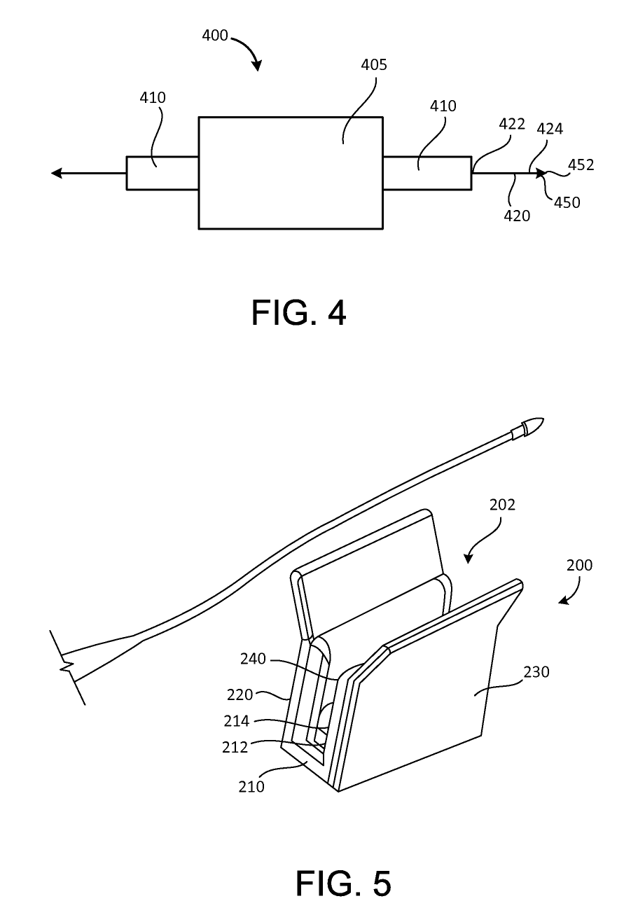

FIG. 2 is a perspective illustration of a medical device or loader 200 according to an embodiment of the invention. FIG. 3 is a perspective view of a delivery tool 300 that may be used with the loader. FIG. 4 is a schematic illustration of an implant 400 that may be coupled to the delivery tool 300 and inserted into a body of a patient. FIGS. 5-10 illustrate the coupling of the implant 400 to the delivery tool 300 according to an embodiment.

The loader 200 includes a base member 210, a first side portion 220, and a second side member 230. The base member 210, the first side member 220, and the second side member 230 collectively define a cavity 240.

In some embodiments, the base member 210, the first side member 220 and the second side member 230 are unitary or are unitarily or monolithically formed. In other words, the base member 210, the first side member 220, and the second side member 230 are formed of a single piece of material. In other embodiments, the base member 210, the first side member 220, and the second side member 230 are separate pieces of material and are coupled together. For example, in some embodiments, the base member 210 is coupled to the first side member 220 and the second side member 230. Specifically, in some embodiments, an adhesive, heat bonding or other mechanism may be used to couple the base member 210 to the first side member 220 and to the second side member 230.

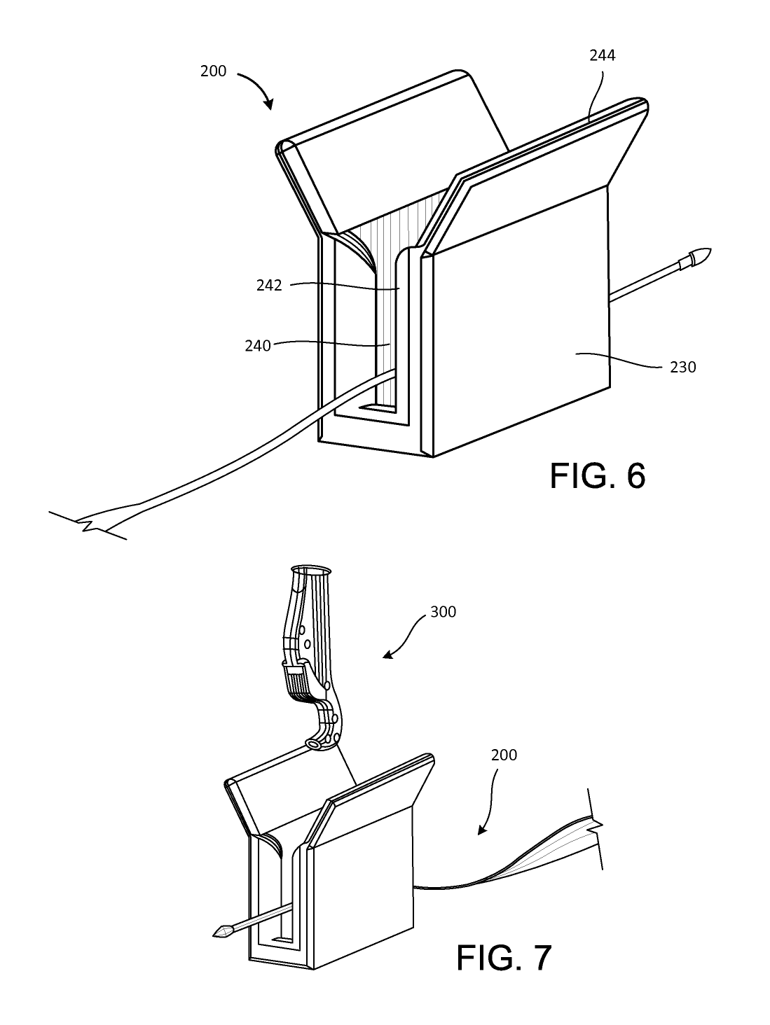

The cavity 240 includes a first end portion 242 and a second end portion 244. The cavity 240 is configured to receive at least a portion of a filament 420. For example, as best illustrated in FIGS. 5 and 6, the cavity 240 is configured to receive the filament 420 such that the filament extends from the first end portion 242 of the cavity 240 to the second end portion 244 of the cavity 240. Specifically, the cavity 240 is configured to receive the filament 420 from a top end or portion 202 of the loader 200. In other embodiments, the cavity is configured to receive the filament 420 from a side portion or end portion of the loader.

In the illustrated embodiment, the top end or portion 202 of the loader 200 includes a flared portion 205. The flared portion 205 is configured to help or facilitate the engaging of a deliver tool with the loader. Specifically, the flared portion 205 helps or facilitates the insertion of the delivery tool into the cavity 240 defined by the loader 200. In the illustrated embodiment, the flared portion 205 includes a portion 225 of the first side member 220 and a portion 235 of the second side member 230. The portion 225 of the first side member 220 extends outwardly from the loader 200. Specifically, the portion 225 of the first side member 220 includes a first end portion 226 that is disposed further from a center of the cavity 240 than a second end portion 227 of the portion 225 of the first side member 220. Similarly, the portion 235 of the second side member 230 extends outwardly from the loader 200. Specifically, the portion 235 of the second side member 230 includes a first end portion 236 that is disposed further from the center of the cavity 240 than a second end portion 237 of the portion 235 of the second side member 230.

In the illustrated embodiment, the first side member 220 includes an extension member 229 that extends into the cavity 240. Similarly, the second side member 230 includes an extension member 239 that extends into the cavity 240. In some embodiments, the extension members 229 and 239 help guide the filament and/or the delivery tool into place within the cavity 240.

As illustrated in FIG. 4, the filament 420 is a portion of or coupled to a support portion 410 of a bodily implant 400. Specifically, the filament 420 extends from the bodily implant 400. In the illustrated embodiment, the filament 420 is a suture, thread, or other thread-like member. In other embodiments, the filament 420 is a member that is extends from the bodily implant 400. In the illustrated embodiment, the implant 400 includes a body portion 405 and two support portions 410. In other embodiments, the implant includes a different number of support portions. In some embodiments, the implant does not include a support portion and the filament is directly coupled to the body portion of the implant.

The filament 420 includes a first end portion 422 coupled to the bodily implant 400. In the illustrated embodiment, the filament 420 also includes a second end portion 424 coupled to a needle 450. In some embodiments, the needle 450 includes a sharp distal end portion 452. The sharp point may be used to penetrate bodily tissue during the delivery of the implant into the body of a patient.

Although in the illustrated embodiment, the second end portion 424 of the filament 420 is coupled to a needle 450, in some embodiments, rather the being coupled to a needle, the filament 420 includes a sharp end portion.

In some embodiments, the filament 420 and the needle 450 are portions of a delivery aid that is coupled to the bodily implant 400 to assist in the implanting or placing of the implant 400 within a body of a patient. In other words, the filament 420 and the needle 450 are not a portion of the implant 400 per se in that they are not configured to remain within the body of the patient after the surgical procedure to place the implant 400 within the body. They are used instead used to assist in the delivery of the implant 400 and are configured to be removed from the implant 400 after the implant 400 has been placed. In other embodiments, the filament 420 and/or the needle 450 are a portion of the implant 400 and are configured to remain within the body of the patient.

The bodily implant 400 can be any type of bodily implant. For example, in some embodiments, the bodily 400 is made of a synthetic material, such as a biocompatible mesh material. In other embodiments, the implant 400 is formed of a natural material. In yet further embodiments, the implant 400 is formed of a combination of synthetic and natural materials.

The implant 400 can be placed at any location within the body of a patient. For example, in some embodiments, the implant 400 can be implanted, for example, through a vaginal incision, in a retro-pubic direction (behind the pubic bone), or in a pre-pubic direction (in front of the pubic bone). In other embodiments, an implant 400 can be placed in the direction of other anatomical structures as desired. A procedure to deploy a pelvic implant can include vaginal incisions, such as an anterior vaginal incision and/or a posterior vaginal incision. In some embodiments, a procedure may include an exterior incision.

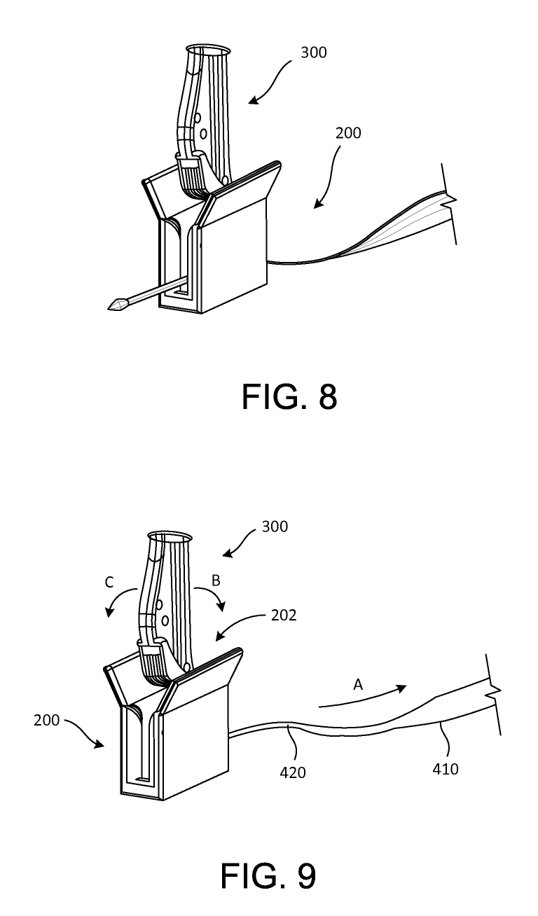

As best illustrated in FIGS. 7 and 8, the cavity 240 is also configured to receive a portion of the delivery tool 300. The delivery tool may be used to insert the implant 400 into the body of the patient.

As illustrated in FIG. 3, in some embodiments, the delivery tool includes a coupling portion 310. The coupling portion is configured to removably couple the filament (and thus, the implant) to the delivery tool. In the illustrated embodiment, the coupling portion 310 includes or defines a slot 320 that is configured to engage and frictionally couple to a filament or a needle. The coupling portion 310 is configured to be inserted into the body of a patient and to extend from the housing towards a catch 330. The catch 330 is configured to receive and couple to the needle that is coupled to the coupling portion 310. Accordingly, the needle can be passed through bodily tissue and received by the catch 330. In some embodiments, the delivery tool is a Capio® as sold by Boston Scientific Corporation.

In some embodiments, the cavity 240 is configured to receive the coupling portion 310 of the delivery tool. For example, in some embodiments, the cavity 240 is configured to receive the coupling portion 310 of the delivery tool 300 such that the coupling portion 310 of the delivery tool 300 is aligned with the filament.

As illustrated in FIG. 9, once the delivery tool 300 has been inserted into the cavity 140, the filament 420 may be moved with respect to the loader 200 and the delivery tool 300. For example, the filament 420 may be moved in the direction of arrow A in FIG. 9 such that the needle 450 that is coupled to the filament 420 contacts or otherwise engages the delivery tool 300. Specifically, in some embodiments, the needle 450 contacts the coupling portion 310 of the delivery tool 300 such that the needle 450 is coupled to the delivery tool 300.

In some embodiments, the delivery tool 300 may be rocked or pivoted within the loader 200 to facilitate the coupling of filament 420 with the delivery tool 300. For example, the delivery tool 300 may be rocked or pivoted in the direction of arrow B or arrow C in FIG. 9 to facilitate the contacting and coupling of the filament 420 to the coupling portion 310 of the delivery tool 300. In some embodiments, a slight extension of the coupling portion 310 from a housing of the delivery tool 300 facilitates the coupling of the filament 420 to the delivery tool 300.

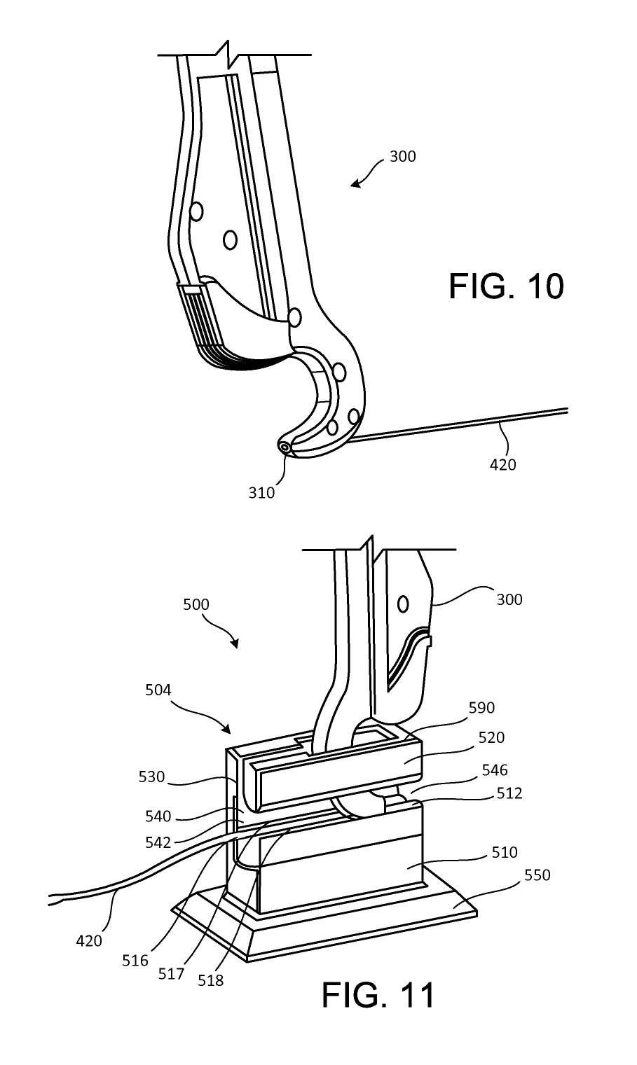

As illustrated in FIG. 10, once the filament 420 is coupled to the delivery tool 300, the delivery tool 300 and the filament 420 may be removed from the loader 100. For example, in some embodiments, the delivery tool 300 and the filament 420 may be lifted out of the top portion 202 of the loader 200. In other embodiments, the delivery tool 300 and the filament 420 may be moved out of a side opening of the loader 200.

In the illustrated embodiment, the base member 210 includes an internal surface 212. The internal surface 212 is internal or at least partially disposed within the cavity 240 defined by the loader 200. In the illustrated embodiment, the internal surface 212 includes a flexible portion 214. For example, in some embodiments, the flexible portion 214 is a compressible portion. Specifically, in some embodiments, the internal surface 212 of the base member 210 includes a compressible material, such as a compressible rubber material coupled to the internal surface 212 of the base member 210. In other embodiments, the flexible portion 214 is a compressible portion of the base member 210 and is monolithic or unitarily formed with the base member 210.

In some embodiments, the flexible or compressible portion of the internal surface 212 of the base member 210 allows or facilitates the disposal of the delivery tool 300 onto the cavity defined by the loader 200. Additionally, in some embodiments, the flexible or compressible portion 214 of the base member 210 facilitates the coupling of the needle 450 or filament 420 to the delivery tool 300. For example, the flex or compression of the flexible portion 214 may facilitate the alignment of the coupling portion 310 of the delivery tool 300 with the filament 420 as the filament is disposed within the cavity 240 defined by the loader 200.

FIG. 11 is a perspective view of another embodiment of a loader 500. The loader 500 includes a base member 510, a first side member 520, and a second side member 530. The base member 510, the first side member 520, and the second side member 530 collectively define a cavity 540.

The cavity 540 includes a first end portion 542 and a second end portion 544. The cavity 540 is configured to receive at least a portion of a filament, such as filament 420. In the illustrated embodiment, the cavity 540 is configured to receive a filament from a side portion 502 of the loader 500. Specifically, the first side member 520 of the loader 500 is coupled to the second side member 530 via an end member 590. The first side member 520 is disposed a distance from the base member 510. Accordingly, the loader 500 is configured to receive the filament into the cavity 540 via the opening defined by the base member 510 and the first side member 520. In other words, the filament may be inserted into the cavity 540 by sliding or moving the filament between the first side member 520 and the base member 510.

As illustrated in FIG. 11, a top portion 504 of the loader 500 is “U” shaped. Specifically, the first side member 520, the second side member 530, and the end member 590 form each of the 3 sides of the “U” shaped top portion of the loader 500.

In the illustrated embodiment, the base member 510 includes an interior surface 512. The interior surface 512 includes a trough or a groove 516. In the illustrated embodiment, the trough or groove 516 extends from one end portion 542 of the cavity 540 to an opposite end portion 544 of the cavity. The trough or groove 516 is configured to receive the filament to help facilitate the alignment of the filament with the receiver portion of the delivery tool.

In the illustrated embodiment, the interior surface 512 of the base member 510 includes a first angled surface 517 and a second angled surface 518. The angled surfaces 517 and 518 form a “V” shaped groove or trough 516. In other embodiments, the groove or trough has a shape other than a “V” shape. For example, in some embodiments, the groove or trough has a “U” shape or a rounded shape.

In the illustrated embodiment, the loader 500 includes a coupling portion 550. The coupling portion 550 is configured to couple the loader 500 to a larger object. In the illustrated embodiment, the coupling member 550 is a magnet and is configured to couple the loader 500 to the surface a metal object, such as a metal table or a table that includes metal.

In some embodiments, the coupling member 550 is coupled to the base member 510. For example, in some embodiments, the coupling member 550 is coupled to the base member 510 via an adhesive, tack, staple, or other coupling means. In other embodiments, the coupling member 550 is integral to and/or unitarily formed with the base member 510.

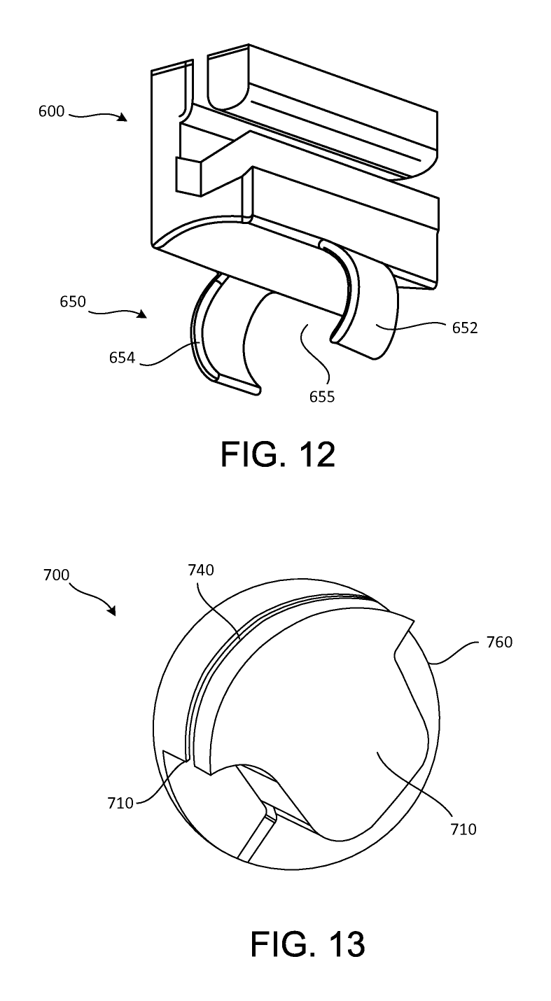

As illustrated in FIG. 12, in one embodiment, a loader 600 includes a coupling portion 650 configured to couple the loader 600 to a portion of a body of a physician or user. For example, in some embodiments, the coupling portion 650 is configured to receive and couple to a finger of the physician or user. Specifically, the coupling portion 650 includes a first projection 652 and a second projection 654. The first projection 652 and the second projection 654 define a receiving portion 655 configured to receive a portion of a finger of a physician. Accordingly, a physician or user of the loader 600 may couple the loader 600 to his or her finger and load the delivery tool as needed during a surgery.

In the illustrated embodiment, the first projection 652 and the second projection 654 each extend from a lower portion of a base member 610 and include curved portions. In other embodiments, the projections 652 and 654 extend from different portions of the loader 600. In further embodiments, the projections 652 and 654 are substantially linear. In some embodiments, the projections 652 and 654 are flexible and are configured to flex to receive a portion of the body of the physician or user to frictionally couple the loader 600 to the body of the physician.

In some embodiments, a loader includes a coupling portion that is configured to couple the loader to a packaging of the implant. For example, in some embodiments, an implant that may be placed within a body of a patient using a delivery tool is shipped in a packaging, such as a clam shell or other type of packaging. In some embodiments, the loader is configured to be coupled to the packaging. In some embodiments, the loader is unitarily or monolithically formed with such packaging and extends from the packaging.

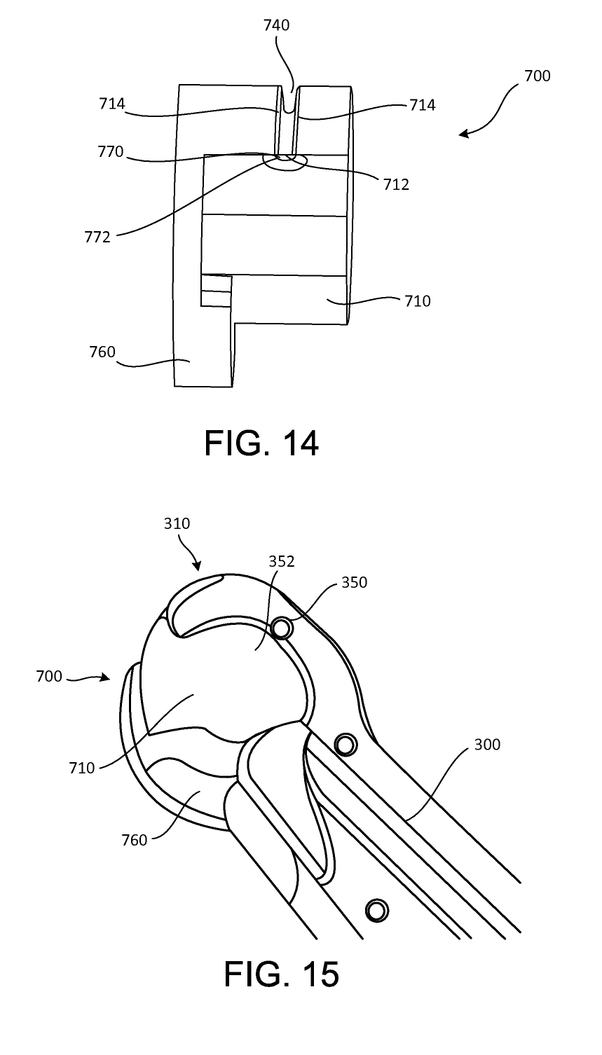

FIG. 13 is a perspective view of a loader 700. FIG. 14 is a side view of the loader 700. FIG. 15 is a perspective view of the loader 700 engaged with delivery tool 300.

The loader 700 includes a base portion or member 710 and a stop portion or member 760. The base member 710 is coupled to the stop member 760. In some embodiments, the base member 710 and the stop member 760 are unitarily or monolithically formed. In other embodiments, the base member 710 and the stop member 760 are separate pieces of material and are coupled together using an adhesive, a tack, a staple or the like.

As best illustrated in FIG. 14, the base member 710 defines a cavity 740. The cavity 740 is configured to receive a filament, such as filament 420 of implant 400. In the illustrated embodiment, the base member 710 includes a base wall 712, a first side wall 714, and a second side wall 716 that collectively define the cavity 740. The cavity 740 is configured to slidably receive a filament. In other words, a filament may be disposed within and moved with respect the to the cavity 740.

In the illustrated embodiment, the base member 710 includes a coupling portion 770. The coupling portion 770 is configured to removably couple the filament 420 to the loader 700. For example, in the illustrated embodiment, the coupling portion 770 is an opening or a keyhole 772 that is configured to receive a filament. As some pressure is applied to the filament, the filament and a needle coupled to an end portion of the filament will pass through the opening or keyhole 772 to release the filament from the loader 700. Specifically, in some embodiments, the coupling portion 770 that defines the opening or keyhole 772 is configured to bend or flex to allow the passage of the needle upon the application of pressure (i.e., the pulling of the filament). The coupling portion 770 is configured to retain the filament coupled to the loader 700 in the absence of sufficient pressure to force the needle through the opening or keyhole 772.

In other embodiments, the coupling portion 770 includes another mechanism configured to removably or releasably couple the filament to the loader 700. For example, in some embodiments, the coupling portion 770 includes an adhesive or a movable or flexible clip configured to couple the filament to the loader 700. In some embodiments, the coupling portion 770 is configured such that the filament may be re-coupled to the loader 700. In other embodiments, the coupling portion 770 is not configured to be re-coupled to the loader 700. In other words, once the filament 420 removed from or decoupled from the loader 700 the filament 420 or another filament, may not be coupled to the loader 700 via the coupling portion 770.

As best illustrated in FIG. 15, the loader 700 is configured to be associated with a delivery tool, such as delivery tool 300. Specifically, the loader 700 is configured to be associated with a delivery tool 300 such that the coupling portion 310 of the delivery tool 300 is aligned with a filament coupled to the loader 700. In the illustrated embodiment, the delivery tool 300 includes a curved portion 350 that defines, or at least partially, defines an opening 352. The loader 700 is configured to be associated with the delivery tool 300 such that at least a portion of the base member 710 is disposed within the opening 352 and at least a portion of the stop member 760 contacts a portion of the curved portion 350 of the delivery tool 300. The contacting of the stop member 760 with the curved portion 350 helps ensure that the loader 700 is correctly associated with the delivery tool 300. In other embodiments, other mechanisms may be used to ensure a correct association. For example, in some embodiments, the base member 710 may include a slanted side wall that prohibits the loader 700 from being advanced too far into the opening 352 defined by the curved portion 350 of the delivery tool 300.

Once the loader is associated with the delivery tool 300, the filament coupled to the loader 700 is aligned with the coupling portion 310 of the delivery tool 300. Accordingly, the filament may be moved with respect to the loader 700 and the delivery tool 300 to remove the filament from the loader 700 and couple or associate the filament (or the needle) with the coupling portion 310 of the delivery tool 300. In the illustrated embodiment, the movement of the filament and the needle with respect to the coupling portion 310 of the delivery tool 300 facilitates or causes the needle and the filament to be coupled to the delivery tool 300.

Once the filament 420 and/or the needle 450 is associated or coupled to the delivery tool 300, the loader 700 may be disassociated with the deliver tool 300. Specifically, the loader 700 may be removed from the opening 352 defined by the curved portion 320 of the delivery tool 300.

In some embodiments, the loader 700 may be preloaded. In other words, in some embodiments, the loader 700 may be shipped to a physician or a user with the filament coupled to the loader 700. In other embodiments, the physician or user of the loader 700 may couple or associate the filament with the loader 700 prior to associating the loader 700 with the delivery tool 300. In yet further embodiments, the loader 700 may be associated with the delivery tool 300 and then the filament may be associated with the loader 700.

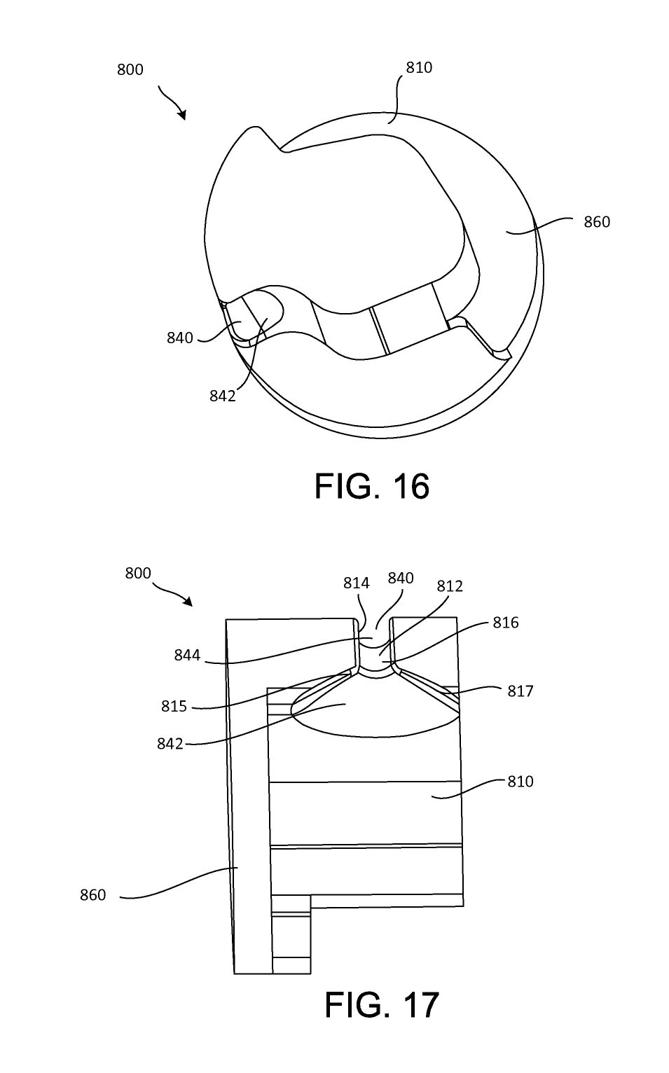

FIG. 16 is a perspective view of a loader 800 according to an embodiment. FIG. 17 is a side view of the loader 800.

The loader 800 includes a base member 810 and a stop member 860. The base member 810 is coupled to the stop member 860. In some embodiments, the base member 810 and the stop member 860 are unitarily or monolithically formed. In other embodiments, the base member 810 and the stop member 860 are separate pieces of material and are coupled together using an adhesive, a tack, a staple or the like.

As best illustrated in FIG. 17, the base member 810 defines a cavity 840. The cavity 840 is configured to receive a filament, such as filament 420 of implant 400. In the illustrated embodiment, the base member 810 includes a base wall 812, a first side wall 814, and a second side wall 816 that collectively define the cavity 840. The cavity 840 is configured to slidably receive the filament.

The cavity 840 defined by the base member 810 includes a first portion (flared or funnel portion) 842 and a second portion 844. The first portion 842 is larger than the second portion 844. In the illustrated embodiment, the first side wall 814 includes a curved portion 815 that curves away from the second side wall 816 (and curves away from a longitudinal axis of the cavity 840) to form a first portion of the flared or funnel portion 842 of the cavity 840. Similarly, the second side wall 816 includes a curved portion 817 that curves away from the first side wall 814 (and curves away from the longitudinal axis of the cavity 840) to form a second portion of the flared or funnel portion 842 of the cavity 840.

The flared or funnel portion 842 of the cavity 840 is configured to facilitate or help a physician or a user of the loader 800 associate a filament with the loader 800. Specifically, the physician or user may associate a filament with the flared or funnel portion 842 of the cavity 840 and then move or side the filament towards the second (smaller) portion 844 of the cavity 840.

Similar to the loader 700, the loader 800 may be associated with a delivery tool such that a coupling portion 310 of the delivery tool is aligned with the cavity 840 of the loader 800. The filament may then be moved with respect to the loader 800 and the delivery tool to associate and couple the filament to the coupling portion of the delivery tool.

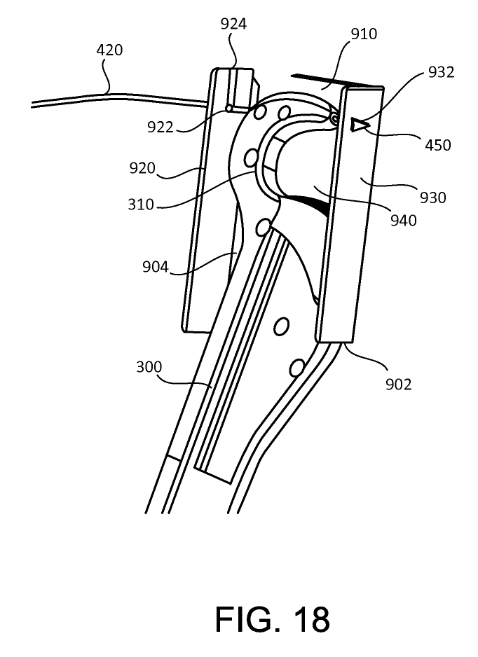

FIG. 18 is a perspective view of a loader 900 according to an embodiment associated with a delivery tool. The loader 900 includes a base member 910, a first side portion 920, and a second side member 930. The base member 910, the first side member 920, and the second side member 930 collectively define a cavity 940.

In some embodiments, the base member 910, the first side member 920 and the second side member 930 are unitary or are unitarily or monolithically formed. In other words, the base member 910, the first side member 920, and the second side member 930 are formed of a single piece of material. In other embodiments, the base member 910, the first side member 920, and the second side member 930 are separate pieces of material and are coupled together. For example, in some embodiments, the base member 910 is coupled to the first side member 920 and the second side member 930. Specifically, in some embodiments, an adhesive, heat bonding or another mechanism may be used to couple the base member 910 to the first side member 920 and to the second side member 930.

In some embodiments, loader 900 is collapsible. In some embodiments, the loader 900 has a first, collapsed configuration and a second, expanded configuration. Specifically, in some embodiments, the first side member 920 and the second side member 930 may be folded or pivoted with respect to and toward the base member 910 to place the loader 900 in its collapsed configuration. In some such embodiments, the first side member 920 and the second side member 930 are pivotally coupled, for example via a hinge mechanism or a living hinge, to the base member 910.

In the illustrated embodiment, the first side member 920 defines an opening 922. The opening 922 is configured to removably receive a filament, such as filament. For example, in the illustrated embodiment, the opening 922 is configured to slideably receive the filament. The first side member 920 defines a slot 924 that communicates with the opening 922. Accordingly, the filament 420 may be inserted into or removed from the opening 922 via the slot 924.

The second side member 930 defines an opening 932. The opening 932 is configured to removably receive a filament, such as filament 420. Accordingly, the loader 900 is configured to receive the filament 420, such that the filament to extends through the opening 922 defined by the first side member 920 to the opening 932 defined by the second side member 930. In the illustrated embodiment, the portion of the second side member 930 that defines the opening 932 is configured to bend or flex to allow the needle 450 to pass through the opening. In other embodiments, another type of coupling allows the filament 420 and the needle 450 to be removably coupled to the loader 900.

As illustrated in FIG. 18, the delivery tool 300 may be disposed within the cavity 940 defined by the loader 900. Specifically, the delivery tool 300 may be disposed within the cavity 940 such that the coupling portion 310 of the delivery tool 300 is aligned with the filament 420. In some embodiments, the delivery tool 300 may be slide or moved into the cavity 940 from an end portion 902 of the loader 900. In another embodiment, the delivery tool 300 may be moved into the cavity from a top portion 904 of the loader 900.

The filament 420 and/or needle 450 may be associated with and/or coupled to the delivery tool 300 by moving or sliding the filament 420 with respect to the loader 900 and the delivery tool 300 such that the needle 450 passes through the opening 932 defined by the second side member 930 and towards the delivery tool 300. In some embodiments, the needle 450 engages and couples to the coupling portion 310 of the delivery tool 300.

Once the filament 420 and/or the needle 450 are engaged with or coupled to the delivery tool 300, the filament 420 may be removed from the opening 922 defined by the first side member 920 (for example, through the slot 924) and the delivery tool 300 may be removed from the cavity 940 defined by the loader 900. The delivery tool 300 may then be used to insert the filament 420, needle 450 and associated implant (not illustrated) into a body of a patient. In some embodiments, the delivery tool 300 may then be coupled to another filament of the same or a different implant for placing such filament and implant into the body of the patient.

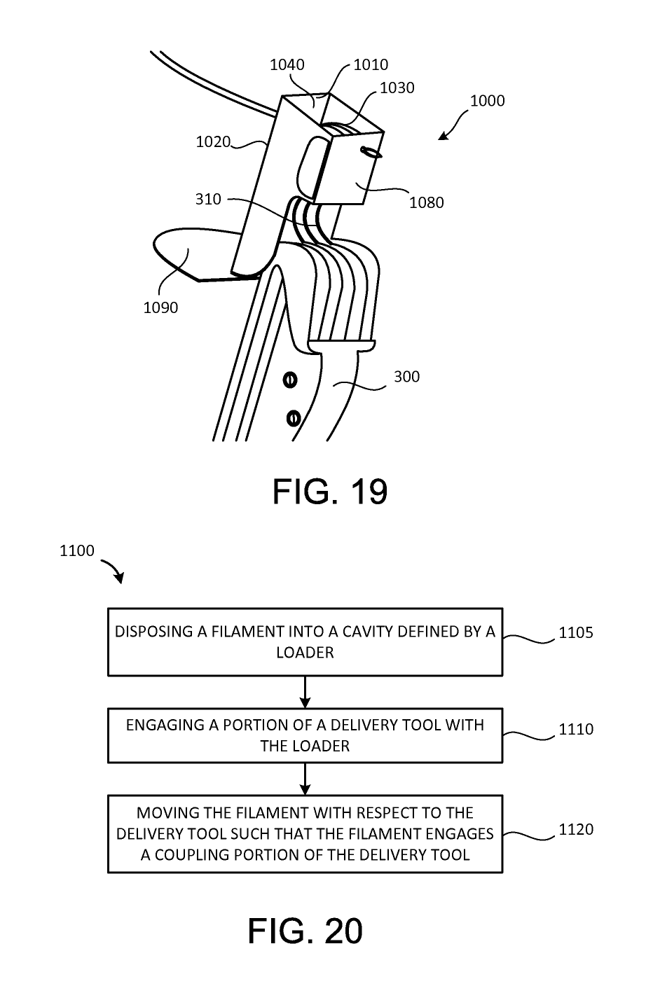

FIG. 19 is a perspective view of a loader 1000 according to an embodiment associated with a delivery tool. The loader 1000 includes a base member 1010, a first side portion 1020, a second side member 1030, and a top member 1080. The base member 1010, the first side member 1020, the second side member 1030, and the top member 1080 collectively define a cavity 1040.

In some embodiments, the base member 1010, the first side member 1020, the second side member 1030, and the top member 1080 are unitary or are unitarily or monolithically formed. In other words, the base member 1010, the first side member 1020, the second side member 1030, and the top member 1080 are formed of a single piece of material. In other embodiments, the base member 1010, the first side member 1020, the second side member 1030, and the top member 1080 are separate pieces of material and are coupled together via an adhesive, heat bonding or another mechanism.

In the illustrated embodiment, the loader 1000 includes a tab 1090. The tab is configured to facilitate the insertion and removal of the a delivery tool, such as delivery tool 300, from the loader 1000. As illustrated in FIG. 19, the cavity 1040 is configured to receive at least a portion of the delivery tool 300. Specifically, in the illustrated embodiment, the cavity is configured to receive the delivery tool 300 such that the coupling portion of the delivery tool is aligned with the filament 420 (which is removably coupled to the loader 1000). In some embodiments, the tab 1090 may be configured to be coupled to the filament 420. In such embodiments, movement of the tab 1090 may cause the filament to move with respect to the loader 900 and/or the delivery tool 300.

In some embodiment, as illustrated in FIG. 20, a method 1100 of loading a delivery tool includes engaging a portion of the delivery tool with a loader (1110) and moving a filament with respect to the delivery tool, such that the filament engages a coupling portion of the delivery tool (1120). In some embodiments, the method includes disposing the filament into a cavity defined by the loader prior to engaging a portion of the delivery tool with the loader (1105). For example, in some embodiments, the filament is placed into the cavity via an opening defined by a top portion of the loader. In other embodiments, the filament is placed into the cavity via an opening defined by a side portion of the loader. In some embodiments, the disposing the filament into the cavity includes disposing the filament into the cavity such that the filament extends from a first end portion of the cavity to a second end portion of the cavity.

In some embodiments, the engaging a portion of the delivery tool with the loader includes disposing a coupling portion of the delivery tool into a cavity defined by the loader.

In some embodiments, the method includes advancing the coupling portion of the delivery tool from an end portion of the delivery tool. For example, the coupling portion may be advanced from and end portion of the delivery tool to facilitate the coupling of the filament (or a needle) to the coupling portion of the delivery tool.

In some embodiments, an apparatus includes a base portion, a first side portion, and a second side portion. The base portion, the first side portion, and the second side portion collectively define a cavity. The cavity is configured to receive a filament. The cavity is configured to receive at least a portion of a delivery tool such that a coupling portion of the delivery tool is aligned with the filament. In some embodiments, the base portion includes an internal surface. The internal surface includes a groove extending from the first end portion of the cavity to the second end portion of the cavity. In some embodiments, the base portion includes an internal surface that includes a flexible portion.

In some embodiments, the apparatus includes a coupling portion configured to couple the apparatus to a surface of another object. In some embodiments, the apparatus includes a coupling portion having a first extension member and second extension member. The first extension member, the second extension member, and a portion of the base member defining a receiving portion configured to receive a portion of a finger of a user.

In some embodiments, the second side portion and the base portion collectively define a slot. The slot is in communication with the cavity and is configured to receive the filament.

In some embodiments, the apparatus includes an end portion extending between the first side portion and the second side portion and being spaced from the base portion.

In some embodiments, the cavity includes a first end portion and a second end portion. The cavity is configured to receive the filament such that it extends from the first end portion of the cavity to the second end portion of the cavity. In some embodiments, the cavity includes a first end portion and a second end portion. The cavity is configured to receive the filament such that it extends from the first end portion of the cavity to the second end portion of the cavity. The cavity is configured to receive the at least a portion of a delivery tool such that the coupling portion of the delivery tool is disposed between the first end portion of the cavity and the second end portion of the cavity.

In some embodiments, the first side portion defines an opening configured to receive the filament and the second side portion defines an opening configured to receive the filament. In some embodiments, the first side portion defines an opening. The second side portion defines an opening. The filament is configured to extend through the opening defined by the first side portion, through the cavity, and through the opening defined by the second side portion.

In some embodiments, at least one of the first side portion, the second side portion, and the base portion is coupled to packaging of a bodily implant.

In some embodiments, an apparatus includes a base portion and a stop portion. The base portion defines a cavity configured to receive a filament. The stop portion is coupled to the base portion and is configured to engage a delivery tool such that a coupling portion of the delivery tool is aligned with the filament. In some embodiments, the base portion includes a coupling portion that is configured to couple the filament to the base portion. In some embodiments, the cavity includes a funnel portion.

In some embodiments, the cavity defined by the base portion has a first end portion and a second end portion. The stop portion is configured to align an end portion of the delivery tool with the second end portion of the cavity.

In some embodiments, a method of loading a delivery tool includes engaging a portion of the delivery tool with a loader and moving a filament with respect to the delivery tool such that the filament engages a coupling portion of the delivery tool.

In some embodiments, the method includes disposing the filament in a cavity defined by the loader prior to the engaging. In some embodiments, the engaging includes disposing a portion of the delivery tool within a cavity defined by the loader.

In some embodiments, the method includes advancing the coupling portion of the delivery tool from an end portion of the delivery tool.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. An apparatus, comprising:
a base portion;
a first side portion;
a second side portion;
the base portion, the first side portion, and the second side portion collectively defining a cavity, the cavity being configured to receive a filament, the cavity being configured to receive at least a portion of a delivery tool such that a coupling portion of the delivery tool is aligned with the filament.

2. The apparatus of claim 1, wherein the base portion includes an internal surface, the internal surface includes a groove extending from the first end portion of the cavity to the second end portion of the cavity.

3. The apparatus of claim 1, wherein the base portion includes an internal surface, the internal surface includes a flexible portion.

4. The apparatus of claim 1, further comprising:
a coupling portion configured to couple the apparatus to a surface of another object.

5. The apparatus of claim 1, further comprising:
a coupling portion having a first extension member and second extension member, the first extension member, the second extension member, and a portion of the base member defining a receiving portion configured to receive a portion of a finger of a user.

6. The apparatus of claim 1, wherein the second side portion and the base portion collectively define a slot, the slot being in communication with the cavity and being configured to receive the filament.

7. The apparatus of claim 1, further comprising:
an end portion extending between the first side portion and the second side portion and being spaced from the base portion.

8. The apparatus of claim 1, wherein the cavity includes a first end portion and a second end portion, the cavity being configured to receive the filament such that it extends from the first end portion of the cavity to the second end portion of the cavity.

9. The apparatus of claim 1, wherein the cavity includes a first end portion and a second end portion, the cavity being configured to receive the filament such that it extends from the first end portion of the cavity to the second end portion of the cavity, the cavity being configured to receive the at least a portion of a delivery tool such that the coupling portion of the delivery tool is disposed between the first end portion of the cavity and the second end portion of the cavity.

10. The apparatus of claim 1, wherein the first side portion defines an opening configured to receive the filament, the second side portion defines an opening configured to receive the filament.

11. The apparatus of claim 1, the first side portion defines an opening, the second side portion defines an opening, the filament being configured to extend through the opening defined by the first side portion, through the cavity, and through the opening defined by the second side portion.

12. The apparatus of claim 1, wherein at least one of the first side portion, the second side portion, and the base portion is coupled to packaging of a bodily implant.

13. An apparatus, comprising
a base portion defining a cavity configured to receive a filament; and
a stop portion coupled to the base portion and configured to engage a delivery tool such that a coupling portion of the delivery tool is aligned with the filament.

14. The apparatus of claim 13, wherein the base portion includes a coupling portion configured to couple the filament to the base portion.

15. The apparatus of claim 13, wherein the cavity includes a funnel portion.

16. The apparatus of claim 13, wherein the cavity defined by the base portion has a first end portion and a second end portion, the stop portion being configured to align an end portion of the delivery tool with the second end portion of the cavity.

17. A method of loading a delivery tool, comprising:
engaging a portion of the delivery tool with a loader; and
moving a filament with respect to the delivery tool, such that the filament engages a coupling portion of the delivery tool.

18. The method of claim 17, further comprising:
disposing the filament in a cavity defined by the loader prior to the engaging.

19. The method of claim 17, wherein the engaging includes disposing a portion of the delivery tool within a cavity defined by the loader.

20. The method of claim 17, further comprising:
advancing the coupling portion of the delivery tool from an end portion of the delivery tool.
